(19) United States
(12) Patent Application Publication
(10) Pub. No.: US 2012/0023083 A1
(43) Pub. Date: Jan. 26, 2012

(54) University Job Search Engine

(76) Inventors: Brin McCagg, New York, NY (US); Skiddy von Stade, New York, NY (US); Chris Piazza, Katonah, NY (US)

(21) Appl. No.: 13/010,565

(22) Filed: Jan. 20, 2011

Related U.S. Application Data
(60) Provisional application No. 61/300,012, filed on Jan. 31, 2010.

(51) Int. Cl. G06F 17/30

(52) U.S. Cl. 707/706; 707/E17.014

(57) ABSTRACT

A plurality of job candidates have corresponding candidate profiles. Each candidate may be associated with a corresponding candidate entity. For example, the job candidates may be students or recent graduates of universities, in which case the candidate profile of each candidate is associated with that candidate's university. Each university may block one or more criteria in its candidates' profiles from being searched. A computer-implemented system matches the candidate profiles with job profiles provided by employers. The matching process takes into account the criteria blocked by the candidate entities (e.g., universities). As a result, when the matching process matches a particular job profile against a particular candidate profile, the matching process does not match criteria in the particular job profile which are blocked by the profile of the candidate entity associated with the particular candidate profile.

### CROSS-REFERENCE TO RELATED APPLICATIONS

This application claims priority from co-pending and commonly-owned U.S. Provisional Patent Application Ser. No. 61/300,012, filed on Jan. 31, 2010, entitled, “University Job Search Engine,” which is hereby incorporated by reference herein.

### BACKGROUND

All organizations are familiar with the high cost of recruiting qualified employees, especially student candidates. Further, today's human resources departments have less time than ever to find such employees. Moreover, it is not enough to find employees with impressive credentials if those employees do not closely match the precise needs of the organization. On the other hand, universities have an interest in promoting all of their students according to various strengths. As a result of these and other factors, old-fashioned solutions for matching candidates to organizations in need of employees are ineffective, inefficient, and expensive.

### SUMMARY

A plurality of job candidates have corresponding candidate profiles. Each candidate may be associated with a corresponding candidate entity. For example, the job candidates may be students or recent graduates of universities, in which case the candidate profile of each candidate is associated with that candidate's university. Each university may block one or more criteria in its candidates' profiles from being searched. A computer-implemented system matches the candidate profiles with job profiles provided by employers. The matching process takes into account the criteria blocked by the candidate entities (e.g., universities). As a result, when the matching process matches a particular job profile against a particular candidate profile, the matching process does not match criteria in the particular job profile which are blocked by the profile of the candidate entity associated with the particular candidate profile.

For example, one embodiment of the present invention is directed to a computer-implemented method for use with a system. The system includes: (A) a plurality of candidate profiles, wherein each of the plurality of candidate profiles defines a corresponding plurality of candidate criteria; (B) a plurality of candidate entity profiles, wherein each of the plurality of candidate entity profiles is associated with at least one of the plurality of candidate profiles, and wherein a first one of the plurality of candidate entity profiles defines at least one first restricted criterion; and (C) a first job profile defining a first plurality of job criteria. The method comprises performing a search of the plurality of candidate profiles using a first query, wherein the first query includes the first plurality of job criteria except for the at least one first restricted criterion, to produce a first search result set.

### BRIEF DESCRIPTION OF THE DRAWINGS

FIG. 1A is dataflow diagram of a system for creating candidate and job profiles according to one embodiment of the present invention.

FIG. 1B is a dataflow diagram of a system for matching candidate profiles with job profiles, taking into account university profiles which block particular criteria from being searched, according to one embodiment of the present invention.

FIG. 1C is a schematic representation of relationships between university profiles and candidate profiles according to one embodiment of the present invention.

FIG. 2 is a flowchart of a method for matching candidate profiles with job profiles, taking into account university profiles which block particular criteria from being searched, according to one embodiment of the present invention.

### DETAILED DESCRIPTION

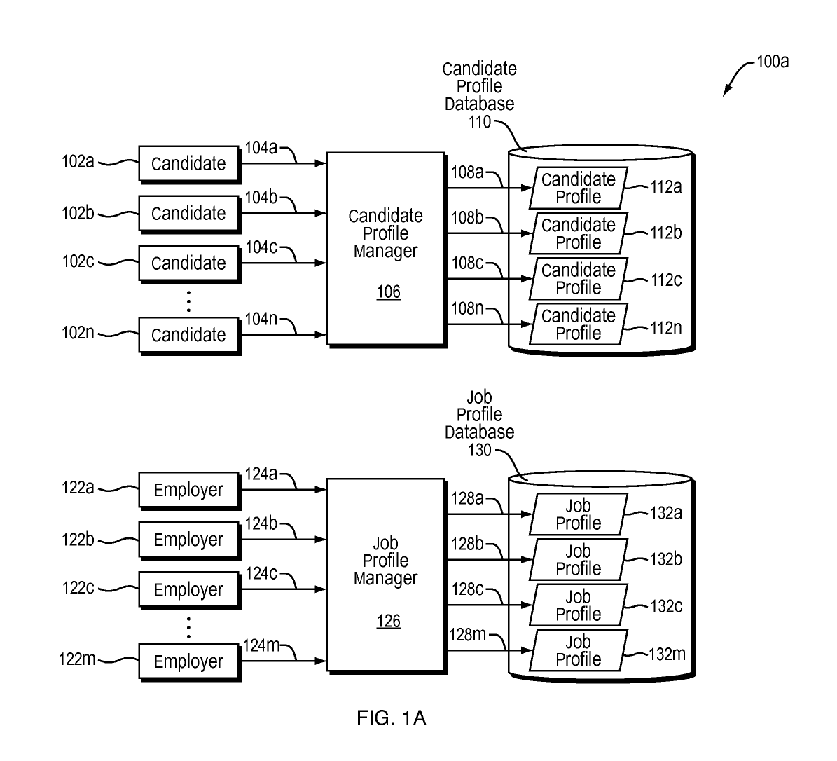

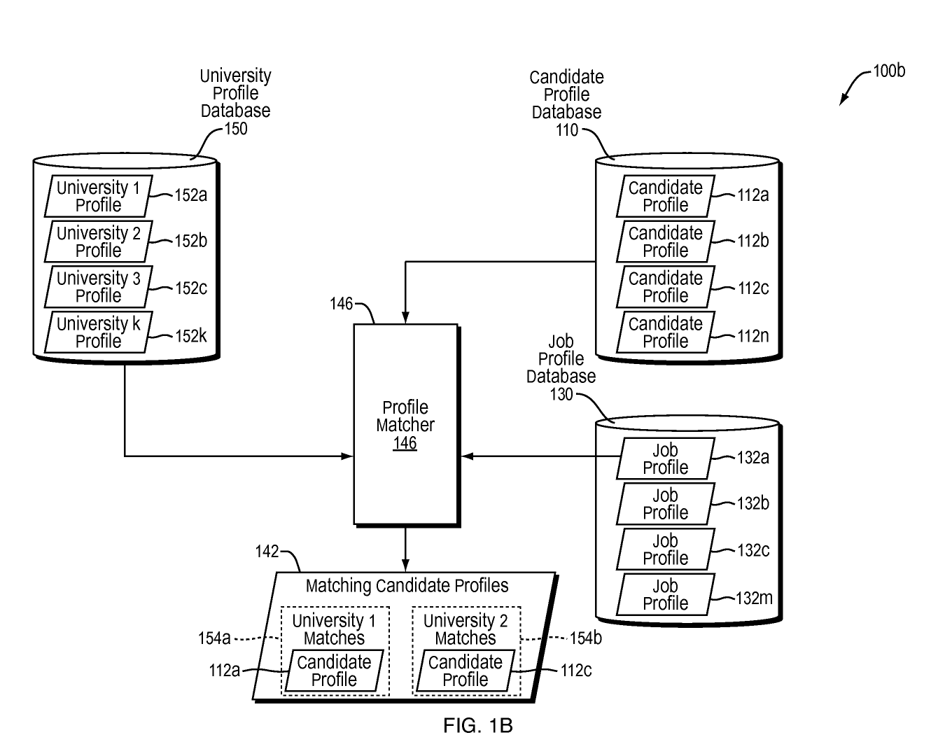

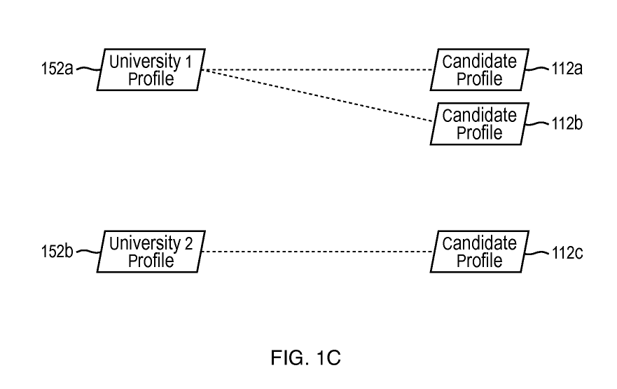

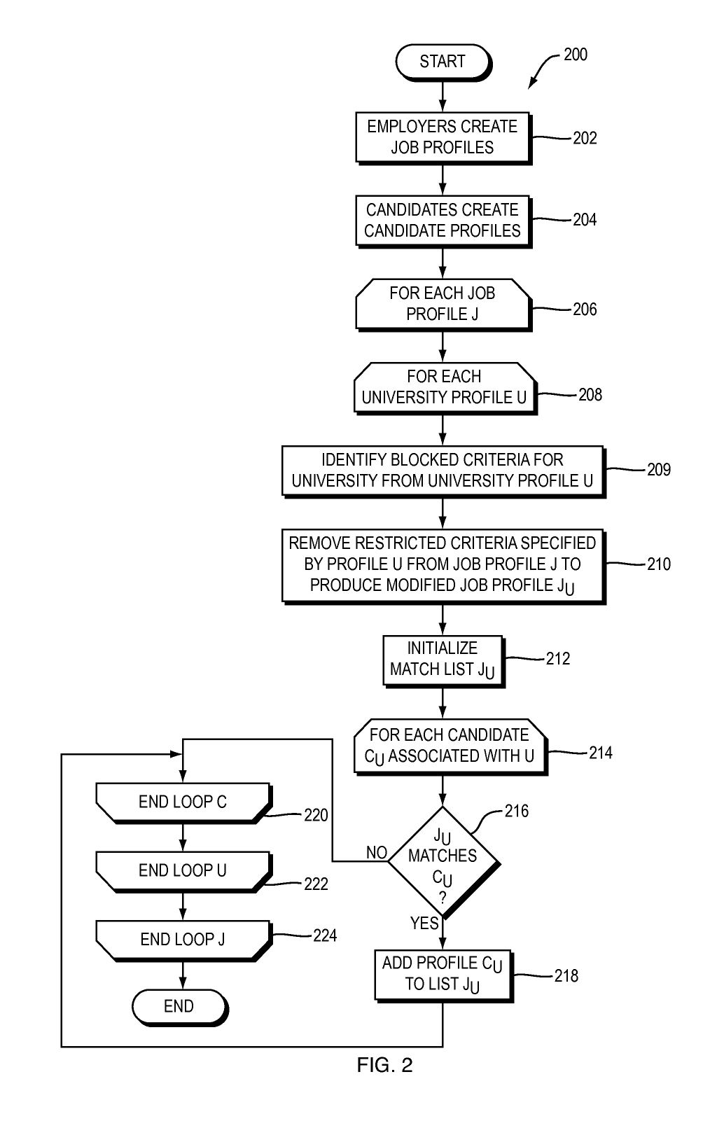

Embodiments of the present invention are directed to systems and methods for matching candidates, such as university students and graduates, with organizations in need of employees. For example, referring to FIG. 1A, a dataflow diagram of a job candidate matching system 100a is shown according to one embodiment of the present invention. Referring to FIG. 2, a flowchart of a method 200 performed by the system 100a of FIG. 1A according to one embodiment of the present invention is shown. These and other embodiments of the present invention may, for example, be implemented as a hosted online system and be accessible to users via the World Wide Web. Although embodiments of the present invention may be implemented using a variety of computing devices, such as desktop or laptop computers, personal digital assistants, or cellular telephones, such hardware is not shown in FIG. 1A for ease of illustration.

Although in certain embodiments described herein, job candidates are students or recent graduates of universities, this is merely an example and does not constitute a limitation of the present invention. More generally, job candidates need not be students or recent graduates. Similarly, a university is merely one example of a “candidate entity” as that term is used herein. A particular job candidate may be associated with a corresponding candidate entity. A single candidate entity may be associated with one or more job candidates. The association between a job candidate and that job candidate's candidate entity may, for example, be that the job candidate currently attends the candidate entity, attended the candidate entity in the past, is currently employed by or a member of the candidate entity, or was employed by or a member of the candidate entity in the past.

In light of the above, any references herein to students and recent graduates should be understood to encompass job candidates more generally. Similarly, in light of the above, any references herein to universities should be understood to encompass candidate entities more generally.

Returning to FIGS. 1A and 2, the system 100a of FIG. 1A may be used by three categories of users: university career services office (CSO) users (e.g., CSO administrators who may configure university settings and CSO counselors who may facilitate recruitment flow for students); organizational users (e.g., employer project managers and other recruiters who work for employers); and job candidates (e.g., students and graduates).

A university CSO user may use the system 100a to create, administer, and/or monitor one or more university accounts and/or student accounts. An employer user may create, administer and/or monitor one or more employer accounts. A student or other job candidate may create, administer, and/or monitor his or her own student account. University CSO users may be given certain privileges to create, administer, and/or monitor accounts of students affiliated with (e.g., in attendance at or recently graduated from) their respective universities.

The system 100a may be used to match candidates with employers during a recruiting season, for example, for the purpose of selecting candidates for job interviews or for obtaining resumes from job candidates. An employer may create a job profile that describes an open position for a particular specified season (e.g., summer 2010). A candidate may opt in to being considered for job profiles and may create or submit a candidate profile containing the candidate's personal information. The job profile may include any number of criteria desired of potential candidates that may be compared with similar actual criteria included in each candidate profile.

The system 100a provides a novel approach to searching, in that universities may actively enforce their policies with respect to restricted search criteria. That is, each particular university may have its own policies regarding which criteria employers may use to search the profiles of students associated with (e.g., in attendance at or graduated from) that university. A university CSO user may configure the system 100a (in connection either with specified recruiting seasons or with respect to all recruiting seasons) to prohibit the system 100a from searching the candidate profiles of students affiliated with that university using criteria which are disallowed (blocked) by that university. If a particular employer job profile specifies a search criterion which is blocked by a particular university, then when the system 100a attempts to match the particular employer job profile against candidate profiles of students associated with (e.g., in attendance at or graduated from) the particular university, the system 100a will actually or effectively remove the blocked criterion from the particular employer job profile, thereby actually or effectively producing a modified job profile for purposes of that particular match (search), and then attempt to match the modified job profile against the candidate profiles of students affiliated with the particular university.

Different universities may specify different blocked criteria to be applied to their own students. The system 100a may, using the techniques just described, produce a different modified version of the particular job profile corresponding to each of the university profiles. The system 100a may, for each such modified job profile, attempt to match the modified job profile against students associated with the corresponding university (i.e., the university whose profile was used to create the modified job profile). As a result, a single job profile may result in the system 100a performing different searches against students affiliated with different universities, in accordance with each of those universities' preferences.

In this way, the universities' profiles 152a-k effectively and automatically override particular criteria in the job profiles 132a-m. This overriding may be unseen by the employers and thereby may serve multiple purposes, such as enabling enforcement of university policies, preserving relationships between the universities and the employers, and eliminating the need for employers to manually create different versions of the same job profile for each university in light of each university's preferences.

More specifically, a CSO user, or other person at a university, may use the system 100a to create a university profile that includes restricted search criteria. Turning back to the restricted search criteria, such criteria may include, for example, the candidate's experience level, geographical location (e.g., city), language skills, board test score(s), distinction(s), computer skills, certification(s), certifying state(s), work authorization(s), sport(s), sport level(s), non-academic honor(s), country of service, branch, studies abroad, experience role(s), job role(s), job title(s), experience level(s), years of experience, scholarship name(s), club name(s), work paper(s), affiliation(s), GPA(s), years out of school, scholarship(s), licenses, citizenship(s), educational background (e.g., major), current position, past experience, salary history, future job goals. In general, CSO users create university profiles 152a-k by providing input to a university profile manager (such as by entering university profile information using a keyboard and mouse through a web-based graphical user interface), which produces corresponding output to create the university profiles 152a-k.

Turning to FIG. 2, a project manager, or other person at an organization that is seeking a person to fill a job position, may use the system 100a to create a job profile that describes the position (step 202). For example, FIG. 1A shows a plurality of employers 122a-m using a job profile manager 126 to create a plurality of corresponding job profiles 132a-m in a job profile database 130. Although four employers 122a-m are shown in FIG. 1A for ease of illustration, more generally any number of employers may use the system 100a. Furthermore, although in the example shown in FIG. 1A, each of the employers 122a-m creates exactly one of the corresponding job profiles 132a-m, this is not a limitation of the present invention. Instead, each of the employers 122a-m may create any number of corresponding job profiles. In general, employers 122a-m create job profiles 132a-m by providing input 124a-m to the job profile manager 126 (such as by entering job profile information using a keyboard and mouse through a web-based graphical user interface), which produces corresponding output 128a-m to create the job profiles 132a-m.

Although elements 122a-m are labeled “employers” in FIG. 1A, and such employers 122a-m may be organizations (such as for-profit or nonprofit corporations, government agencies, or universities), an employer may instead be an individual employer (such as a sole proprietor), or an individual or group within an employer, such as a department or a project manager. Therefore any reference herein to an “employer” or “organization” should be understood to refer equally to any other such entity.

Each of the employers 122a-m may have an account on the system 100a for managing positions for which the employer is seeking candidates. The system 100a may include and enforce security policies which allow only the project manager and other authorized personnel to create, edit, gain approval for, and delete job profiles for the organization. The system 100a may maintain accounts for multiple organizations, each with its own registered project managers or other users, and associated preferences and access rights. A single organization may have multiple accounts. For ease of explanation, however, the following description will refer only to a single project manager at a single organization.

The job profile created by the project manager for a particular position (such as the job profile 132a created by employer 122a) may designate one or universities at which the employer wants to recruit for the corresponding job position. The job profile may include a variety of information about the corresponding job position and the qualifications (or “criteria”) of candidates sought by the organization, such as, the candidate's experience level, geographical location (e.g., city), language skills, board test score(s), distinction(s), computer skills, certification(s), certifying state(s), work authorization(s), sport(s), sport level(s), non-academic honor(s), country of service, branch, studies abroad, experience role(s), job role(s), job title(s), experience level(s), years of experience, scholarship name(s), club name(s), work paper(s), affiliation(s), GPA(s), years out of school, scholarship(s), licenses, citizenship(s), educational background (e.g., major), current position, past experience, salary history, future job goals. The job profile effectively defines university student pools to be searched and a set of search criteria for use by the system 100a to match candidates from those university student pools against the job profile. Further details about information that may be included in the job profile, and ways in which the profile may be used to match organizations with candidates, will be described below.

As noted above, candidates 102a-n (also referred to herein as “job seekers,” who may include, for example, students and graduates of universities) may also maintain their own accounts on the system 100a. An individual candidate may log in to his or her account and create a personal career profile containing a variety of personal information, including candidate's experience level, desired geographical location (e.g., city), language skills, board test score(s), distinction(s), computer skills, certification(s), certifying state(s), work authorization(s), sport(s), sport level(s), non-academic honor(s), country of service, branch, studies abroad, experience role(s), job role(s), job title(s), experience level(s), years of experience, scholarship name(s), club name(s), work paper(s), affiliation(s), GPA(s), years out of school, scholarship(s), licenses, citizenship(s), educational background (e.g., major), current position, salary history, and future job goals (FIG. 2, step 204). Further details about candidates' profiles will be provided below.

For example, FIG. 1A shows a plurality of candidates 102a-n using a candidate profile manager 106 to create a plurality of corresponding candidate profiles 112a-n in a candidate profile database 110. Although four candidates 102a-n are shown in FIG. 1A for ease of illustration, more generally any number of candidates may use the system 100a. In general, candidates 102a-n create candidate profiles 112a-n by providing input 104a-n to the candidate profile manager 106 (such as by entering candidate profile information using a keyboard and mouse through a web-based graphical user interface), which produces corresponding output 108a-n to create the candidate profiles 112a-n.

Once universities, organizations 122a-m, and candidates 102a-n have created their respective profiles 152a-k, 132a-m, and 112a-n, organizations' profiles 132a-mmay be matched against candidates' profiles 112a-n after removing restricted criteria specified by the university profiles 152a-k from the organizations' job profiles 132a-m. In general, any number of job profiles 132a-m may be matched against any number of candidate profiles 112a-n.

The terms “match” and “search” are used interchangeably herein, because searching for job profiles 132a-m against candidate profiles 112a-n involves attempting to find job profiles 132a-m having criteria which sufficiently match the criteria of candidate profiles 112a-n. Each of the job profiles 132a-m, in other words, may be used as a query in a search against the candidate profiles 112a-n.

FIG. 2 shows an example in which all job profiles 132a-m are matched against all candidate profiles 112a-n. In particular, for each of the job profiles 132a-m, a search is performed in an attempt to identify any of the candidate profiles 112a-n which match that job profile.

More specifically, for each of the job profiles J (step 206), and for each of the university profiles U (step 208) designated in job profile J, the profile matcher 146 (FIG. 1B) identifies any restricted criteria specified by the particular university profile U (step 209). The profile matcher 146 removes the identified restricted criteria from job profile J to produce a modified version J_{U} of job profile J (step 210).

If the job profile J does not specify any university profiles, then the profile match 146 may treat such a job profile as if it specifies all of the university profiles 152a-k. In other words, in this case, step 208 may loop over all of the university profiles 152a-k.

The profile matcher 146 initializes an empty “match list” of candidate profiles for modified profile J_{U} (step 212). For each of the candidate profiles C_{U} associated with university profile U (step 214), the profile matcher 146 determines whether modified job profile J_{U} matches candidate profile C_{U} (step 216). Note that although in the embodiment illustrated in FIG. 2, the modified job profile J_{U} is first created and then matched against candidate profiles C_{U}, the same result may be achieved in other ways, such as by using the original job profile J and excluding the restricted criteria associated with university profile U on the fly in step 216, without modifying the job profile J. In other words, the function performed by step 210 in FIG. 2 may alternatively be achieved by excluding the restricted criteria associated with university profile U on the fly in step 216, thereby making the creation of the modified job profile J_{U} optional.

If there is a match, then the profile matcher 146 adds candidate profile C_{U} to the match list for job profile J_{U} (step 218). Steps 216 and 218 repeat for the remaining candidate profiles (step 220), steps 209-220 repeat for the remaining university profiles (step 222), and steps 208-222 repeat for the remaining job profiles (step 224). The result is a match list (i.e., search result set) for each job profile for each university, which contains the candidate profiles (if any) which match that job profile.

FIG. 1B illustrates a simple example of a system 100b in which the profile matcher 146 attempts to match the single job profile 132a against all of the candidate profiles 112a-n in the candidate profile database, taking into account criteria restricted by university profiles 152a-k, to produce matching candidate profiles 142. In the example illustrated in FIG. 1B, two candidate profiles 112a and 112c, from universities 1 and 2 respectively, match job profile 132a. As depicted in FIG. C, each university may be associated with a particular group of candidates. For example, University 1 profile 152a may be associated with Candidate profiles 112a and 112b while University 2 profile 152b may be associated with Candidate profile 112c.

Such matching may be performed in a variety of ways. For example, fields in the job profiles 132a-m may be mapped to fields in candidates' profiles 112a-n and university profiles 152a-k that contain the same type of information. For example, the “geographic location” field of an organizations' job profile, which describes the geographic location of the job position, may be mapped to a “desired geographic location” field of a candidate's profile and a “geographic location” field of a university profile. If both the fields for a particular organization's job position and a particular candidate's profile contain the same information (e.g., “Boston, Massachusetts”), and if the restricted criteria of the university profile does not indicate “geographic location” as a restricted criterion, then the system may consider the “geographic location” and “desired geographic location” fields to match each other. If, on the other hand, the restricted criteria of the university profile does indicate “geographic location” is a restricted criterion, then the “geographic location” and “desired geographic location” fields will not be compared to determine if a match results.

The job profiles 132a-m may contain fields corresponding to all of the fields made available for use in the candidates' profiles 112a-n. As a result, the system 100 may provide project managers with the ability to search for any criteria that candidates may enter in their profiles.

Similarly, the university profiles 152a-k may contain fields corresponding to all of the fields made available for use in the candidates' profiles 112a-n. As a result, the system 100 may provide university CSO representatives with the ability to restrict restricted search criteria thereby overriding an employer's desirable criteria search selections.

This is merely one simple example of how the job position profiles 132a-m may be matched against candidates' profiles 112a-n, taking into account university profiles 152a-k. Any of a variety of well-known techniques may be used to perform more complex matching of profiles. For example, data stored in fields of profiles may contain specific values (such as “Boston, Mass.” for a “Job Location” field), sets of values (e.g., “CEO,” “Vice President,” and “COO” for a “Desired Position” field), or definitions of sets of values (e.g., “$50,000-$100,000” for a “Salary” field). Field values of these and other types may be used in a variety of ways to match values in other fields. For example, if a candidate profile indicates that the candidate's desired salary is in the range of $50,000-$100,000, the profile matcher 146 may consider this to be a match for a position offering a specific salary of $75,000 or a position offering a range of salaries from $60,000-$75,000. Any of a variety of well-known techniques may be used for performing such matching.

Results may be presented on a university by university basis. That is, because the search query may actually be two different search queries for two different universities, candidate results may be displayed to an employer grouped by university. In an alternative embodiment, results may be reassembled together, for example, according common search criteria.

Fields within a profile may be prioritized in any of a variety of ways. For example, a particular job profile may indicate that the “Major” field has a higher priority than the “GPA” field. As another example, a particular job profile may indicate that the value of “Princeton” has a higher priority than a value of “Cornell” as a value of the “College” field. Such prioritization may be performed within university profiles, job profiles and/or within candidate profiles. Priorities may be implemented in any of a variety of ways, such as sequential rankings (e.g., rankings of fields' importance relative to each other) or weightings. The profile matcher 146 may take such priorities into account to determine whether, and the extent to which, a particular job profile matches a particular candidate profile, considering a particular university profile.

Furthermore, certain information not contained with a profile may be used by the profile matcher 146 as part of the matching process. For example, all job profiles created by a specific organization may be treated as if they contain an “employer name” field containing the name (or other unique identifier) of the organization, for purposes of matching such job profiles against candidate profiles. For example, candidates may specify in their candidate profiles that they are interested in pursuing jobs with specific named employers. When matching candidate profiles against job profiles, the system 100 may match candidate's desired employers against the (implicit) “employer name” field in all job profiles, thereby increasing the likelihood that candidates who are interested in employment with specific employers will be considered a match with jobs posted by those employers. This benefits not only the candidates but the employers, who are likely to obtain more motivated and loyal employees if such employees become employed by employers who they were specifically interested in working for.

The matching process performed by the profile matcher 146 may result in scores representing the degree of matching between any particular pair of job position profile and candidate profile. Scores may be normalized along a standardized scale, such as a scale of 0-100, in which 0 indicates no match and 100 represents a perfect match. Such scores may be stored, for example, within the set of matching candidate profiles 142.

The system 100 may periodically generate such scores for all job profiles 132a-m and candidate profiles 112a-n by using the techniques described above to search for candidate profiles that match each of the job profiles 132a-m in the system 100 considering university profiles. The system 100 may notify each organization of any matching candidates for each of the organization's posted job positions. Similarly, the system 100 may notify each candidate of any job positions matching the candidate's profile, and may notify each university of any candidate and job matches.

Organizations may configure their accounts to specify account preferences, such as the frequency with which such searching is to be performed, the minimum matching threshold (e.g., 50%) that a candidate profile must satisfy to be considered a match (also called a “match floor”), and the maximum number of candidate profiles to be included in the list of matching profiles 142 for a particular job. Candidates and universities may configure their accounts with similar preferences.

Among the advantages of the invention are one or more of the following. A university's policies with respect to criteria that they do not want to be considered by employers for their students may be enforced. This enables students at a university to enjoy the benefits of their university's policies. The enforcement of a university's policies is not necessarily evident to the employers thereby enabling the employers to search by all desired candidate criteria without regard to a particular university's policies. This promotes relationships between universities and employers.

It is to be understood that although the invention has been described above in terms of particular embodiments, the foregoing embodiments are provided as illustrative only, and do not limit or define the scope of the invention. Various other embodiments are also within the scope of the invention.

Elements and components described herein may be further divided into additional components or joined together to form fewer components for performing the same functions.

The techniques described above may be implemented, for example, in hardware, software tangibly embodied on a computer-readable medium, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the invention may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a non-transitory computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method for use with a system, wherein the system comprises:
a plurality of candidate profiles, wherein each of the plurality of candidate profiles defines a corresponding plurality of candidate criteria;
a plurality of candidate entity profiles, wherein each of the plurality of candidate entity profiles is associated with at least one of the plurality of candidate profiles, and wherein a first one of the plurality of candidate entity profiles defines at least one first restricted criterion; and
a first job profile defining a first plurality of job criteria;
wherein the method comprises:
(1) performing a search of the plurality of candidate profiles using a first query, wherein the first query includes the first plurality of job criteria except for the at least one first restricted criterion, to produce a first search result set.

2. The method of claim 1, wherein the first search result set includes at least one of the plurality of candidate profiles.

3. The method of claim 1, wherein the at least one first restricted criterion comprises a first plurality of restricted criteria; and
wherein (1) comprises performing a search of the plurality of candidate profiles using a first query, wherein the first query includes the first plurality of job criteria except for the first plurality of restricted criteria, to produce a first result set.

4. The method of claim 1, wherein (1) comprises performing a search of only those candidate profiles in the plurality of candidate profiles which are associated with the first one of the plurality of candidate entity profiles.

5. The method of claim 4, wherein the first job profile specifies the first one of the plurality of candidate entity profiles.

6. The method of claim 4:
wherein a second one of the plurality of candidate entity profiles defines at least one second restricted criterion; and
wherein the method further comprises:
(2) performing a search, using a second query, of only those candidate profiles in the plurality of candidate profiles which are associated with the second one of the plurality of candidate entity profiles, wherein the second query includes the first plurality of job criteria except for the at least one second restricted criterion, to produce a second search result set;
wherein the first query differs from the second query.

7. The method of claim 1:
wherein the first one of the plurality of candidate entity profiles is associated with a first subset of the plurality of candidate profiles;
wherein a second one of the plurality of candidate entity profiles is associated with a second subset of the plurality of candidate profiles; and
wherein the first and second subsets of the plurality of candidate profiles are disjoint.

8. The method of claim 1, wherein:
the system further comprises a second job profile defining a second plurality of job criteria; and
wherein the method further comprises:
(2) performing a search of the plurality of candidate profiles using a second query, wherein the second query includes the first plurality of job criteria except for the at least one second restricted criterion, to produce a second search result set;
wherein the first plurality of job criteria differ from the second plurality of job criteria.

9. The method of claim 1, wherein (1) comprises:
(1)(a) removing the at least one first restricted criterion from the first job profile to produce a first modified job profile defining a modified plurality of job criteria; and
(1)(b) performing a search of the plurality of candidate profiles using the first modified job profile as the first query.

10. The method of claim 9, wherein (1)(b) comprises, for each candidate profile C in the plurality of candidate profiles, determining whether the plurality of candidate criteria corresponding to candidate profile C matches the modified plurality of job criteria.

11. A computer-readable medium for use with a system, wherein the system comprises:
a plurality of candidate profiles, wherein each of the plurality of candidate profiles defines a corresponding plurality of candidate criteria;
a plurality of candidate entity profiles, wherein each of the plurality of candidate entity profiles is associated with at least one of the plurality of candidate profiles, and wherein a first one of the plurality of candidate entity profiles defines at least one first restricted criterion; and
a first job profile defining a first plurality of job criteria;
wherein the computer-readable medium comprises computer-executable instructions tangibly stored on the computer-readable medium, and wherein the computer-executable instructions are executable by a computer processor to perform a method comprising:
(1) performing a search of the plurality of candidate profiles using a first query, wherein the first query includes the first plurality of job criteria except for the at least one first restricted criterion, to produce a first search result set.

12. The computer-readable medium of claim 11, wherein the first search result set includes at least one of the plurality of candidate profiles.

13. The computer-readable medium of claim 11, wherein the at least one first restricted criterion comprises a first plurality of restricted criteria; and
wherein (1) comprises performing a search of the plurality of candidate profiles using a first query, wherein the first query includes the first plurality of job criteria except for the first plurality of restricted criteria, to produce a first result set.

14. The computer-readable medium of claim 11, wherein (1) comprises performing a search of only those candidate profiles in the plurality of candidate profiles which are associated with the first one of the plurality of candidate entity profiles.

15. The computer-readable medium of claim 14, wherein the first job profile specifies the first one of the plurality of candidate entity profiles.

16. The computer-readable medium of claim 14:
wherein a second one of the plurality of candidate entity profiles defines at least one second restricted criterion; and
wherein the method further comprises:
(2) performing a search, using a second query, of only those candidate profiles in the plurality of candidate profiles which are associated with the second one of the plurality of candidate entity profiles, wherein the second query includes the first plurality of job criteria except for the at least one second restricted criterion, to produce a second search result set;
wherein the first query differs from the second query.

17. The computer-readable medium of claim 11:
wherein the first one of the plurality of candidate entity profiles is associated with a first subset of the plurality of candidate profiles;
wherein a second one of the plurality of candidate entity profiles is associated with a second subset of the plurality of candidate profiles; and
wherein the first and second subsets of the plurality of candidate profiles are disjoint.

18. The computer-readable medium of claim 11, wherein:
the system further comprises a second job profile defining a second plurality of job criteria; and
wherein the method further comprises:
(2) performing a search of the plurality of candidate profiles using a second query, wherein the second query includes the first plurality of job criteria except for the at least one second restricted criterion, to produce a second search result set;
wherein the first plurality of job criteria differ from the second plurality of job criteria.

19. The computer-readable medium of claim 11, wherein (1) comprises:
(1)(a) removing the at least one first restricted criterion from the first job profile to produce a first modified job profile defining a modified plurality of job criteria; and
(1) (b) performing a search of the plurality of candidate profiles using the first modified job profile as the first query.

20. The computer-readable medium of claim 19, wherein
(1)(b) comprises, for each candidate profile C in the plurality of candidate profiles, determining whether the plurality of candidate criteria corresponding to candidate profile C matches the modified plurality of job criteria.
